(19) United States
(12) Patent Application Publication
(10) Pub. No.: US 2009/0179132 A1
(43) Pub. Date: Jul. 16, 2009

(54) LAPTOP STAND

(76) Inventors: Zhigang Qin, Shanghai (CN); Judy Zhou, Shanghai (CN)

Correspondence Address: General Electric Company;GE Global Patent Operation, PO Box 861, 2 Corporate Drive, Suite 648, Shelton, CT, 06484, US

(21) Appl. No.: 11/571,162

(22) PCT Filed: Jun. 21, 2005
(86) PCT No.: PCT/US2005/021867

§ 371 Date: Dec. 22, 2006

(30) Foreign Application Priority Data
Jun. 25, 2004 (CN) 200420072701.8

(51) Int. Cl. F16M 11/10

(52) U.S. Cl. 248/371

(57) ABSTRACT

An ergonomic laptop stand, including: a front panel, there are one or more heat dissipation portholes on the said front panel; a base, one end of the said base is pivoted to connect with one end of the said front panel; a supporting plate, it comprises a pivoted end and a locating end which faces the said pivoted end, the said pivoted end can be pivoted to connect with one of the said front panel and the said base; and a plurality of locating members, the said locating members are provided on the other one of the said front panel and the said base; in which, when the said stand supports the laptop, the said locating end can be located on one of the said plurality of locating members separately. According to the invention, the laptop stand can be adjusted to support the laptop at different angles using ergonomic theory; also, while supporting the laptop, the said stand can dissipate fully the heat from the laptop. Moreover, it is very compact and convenient for taking with the laptop, and with lightweight. The material of the laptop stand, which is made of plastic, can be recycled; this is in conformity with the conception of the environmental protection.

### FIELD OF THE INVENTION

The present invention relates to a stand for supporting the office supplies, more specifically, relates to a stand of laptop, in which the angle of supporting plate can be adjusted, and it is easy to be portable.

### RELATED BACKGROUND ART

At present, people are more and more liking to use the laptop because of its portability, however, the laptop users are mostly those who usually go on travel and business, thus, the laptop's screen can not be adjusted at different angles and height as that of the desk computer. As to the user used to the desk computer, since the keyboard of the laptop is designed to be different from and be smaller than that of the usual desk computer, if people use the laptop and the desk computer alternately, they will not adapt themselves to it, which shall affect the speed of keyboard operation. Therefore, the laptop manufacturers have provided the keyboard interface on the laptop, which is compatible with the desk computer. It is apparent to be very convenient for the user to use the keyboard of the usual desk computer to input when they operate the laptop. But there are still some problems, since the laptop is smaller. When it is opened, no matter how to adjust the open angle of its screen, the laptop's screen height on the desk is still lower than that of the desk computer, which makes the user's sight not at the same level as the screen when he operates the laptop. Thus the user has to lower his head, and bend his spinal column and neck spontaneously. The user will feel tired after a long time. If they keep the incorrect posture for a long period, it will lead to some diseases of spinal column and neck. In addition, as the laptop is placed directly on the desk, the heat from the mainframe is not easy to dissipate, which is certain to affect the life of the laptop. Thus, in order to have a certain heating space between the laptop and desk, some under lays like books are placed on the laptop's rear side, but the method looks cumbersome, the heating space is limited, and it is impossible to solve the problem of lowering the user's head.

To solve the problem of heat dissipation, the utility model publication CN 2,554,688Y discloses a laptop backstop for heat dissipation. A backstop is pivoted on the bottom of the laptop's mainframe, and is near to the joint between the main frame and the laptop screen. When the laptop is used, the backstop is opened to lift the laptop rear side, therefore, it can overcome the problem of heat dissipation. Although this structure has solved the problem of heat dissipation, it is still impossible to solve the problem of lowering the user's head.

The utility model publication CN 2,519,943Y discloses a laptop bearer, which can support the laptop at different angles, but its structure is very complicated. The device is equipped with electrical parts, such as optical driver, power supply adapter and contact socket, etc., which makes it very complicated and costly to manufacture.

### SUMMARY OF THE INVENTION

One aspect of the invention is to provide a laptop stand that can be adjusted to support the laptop at different angles using ergonomic theory, while supporting the laptop, and it can dissipate fully the heat from the laptop.

Another aspect of the invention is to provide a laptop stand that is very compact, portable and light.

In order to realize the above and other aspects of the invention, there is provided a laptop stand, which includes: a front panel, there are heat dissipation portholes on the said front panel; a base, one end of the said base is pivoted to connect with one end of the said front panel; a supporting plate; comprising a pivoted end and a locating end which faces the said pivoted end, the said pivoted end can be pivoted to connect with one of the said front panel and the said base; plurality of locating members, the said locating members are provided on the other one of the said front panel and the said base; in which, when the said stand supports the laptop, the said locating end can be located at one of the said plurality of locating members separately.

In the said stand, the pivoted end of the said front panel has two or two more foldable backstops.

In the said stand, when the said stand is folded, the said front panel is clipped to connect with the said base at the at least one position except where the said front panel is pivoted to connect with the said base.

In the said stand, there is provided with protruded table upwardly on the said base, the said plurality of locating members is plurality of parallel grooves placed in the said protruded table.

In the said stand, the said pivoted end is pivoted to connect with the said front panel, and the plurality of locating members is located on said base.

In the said stand, the size of the said heat dissipation porthole is corresponded to the said protruded table so as to make the said protruded table to be accommodated in the said heat dissipation porthole when the said front panel is folded with the said base.

In the said stand, there are provided with retaining ribs on the periphery of the rear side of the said front panel and the said heat dissipation porthole, which are protruded from the rear side of the said front panel.

In the said stand, there are provided with retaining ribs on the rear side of the said front panel, which are corresponded to the peripheral shape of the said base, and retaining ribs which protrude upwardly from the base are provided on the periphery of the said base on which are not pivoted.

In the said stand, the retaining ribs of the said front panel, the retaining ribs of said base and the said protruded table have the same height, and the height is equal to or greater than the thickness of the said supporting plate.

In the said stand, there are provided with three or more than three skid proof pad on bottom surface of the said base, and there are provided with a handle on the said front panel.

According to the invention, there is provided with a laptop stand, it can be adjusted to support the laptop at different angles using ergonomic theory, and adapts to the folded angle of the folded monitor of the laptop to make the height of the monitor of the laptop to be at the same plane as that of the operator's level of sight when the operator sits straight, which can not only correct the posture of the operator, but also furthest lightening the physical harm to his eyes, and it embodies fully humanization from the design of its structure. Also, while supporting the laptop, the said stand can dissipate fully the heat from the laptop; therefore, it can prolong the life of the laptop.

Further, when the laptop stand according to the invention does not support the laptop, it can close the front panel and the base together to fold into a flat plate structure. Since the supporting plate is between the front panel and base, it is very compact and convenient for taking with the laptop and with lightweight.

### BRIEF DESCRIPTION OF THE DRAWINGS

The foregoing and other objects, features and advantages of the invention will become more readily apparent from the following detailed description of the preferred embodiments of the invention in conjunction with the accompanying drawings of which.

FIG. 1 is a perspective view showing from the rear side when the laptop stand according to the invention is opened.

FIG. 2 is a perspective view showing from the front side when the laptop stand according to the invention is opened.

FIG. 3 is a view showing that the said laptop stand is supporting the laptop.

FIG. 4 is a view showing that the operator is operating the laptop when the said laptop stand is supporting the laptop.

### DESCRIPTION OF THE PREFERRED EMBODIMENTS

The invention will be described in details from the preferred embodiment when read in connection with the accompanying drawings, to facilitate understanding; identical reference numerals refer to the identical elements throughout.

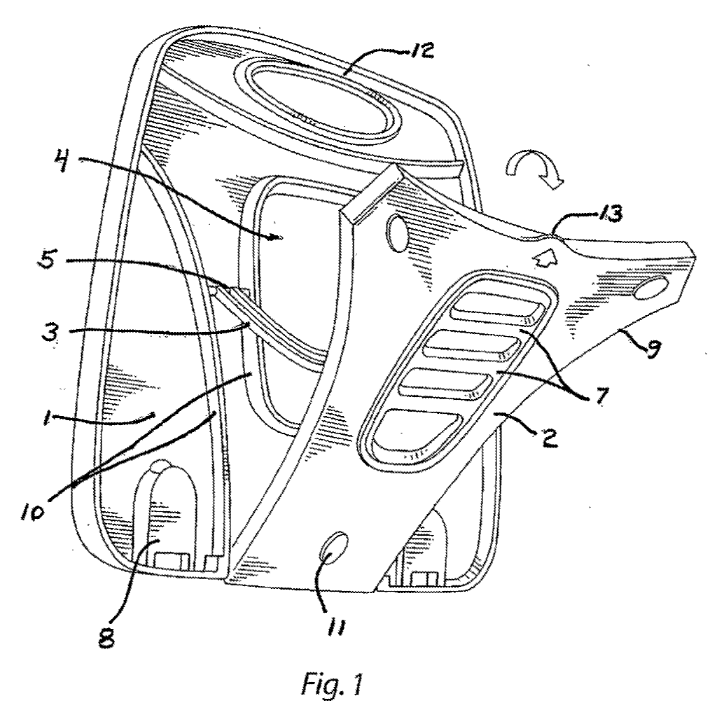

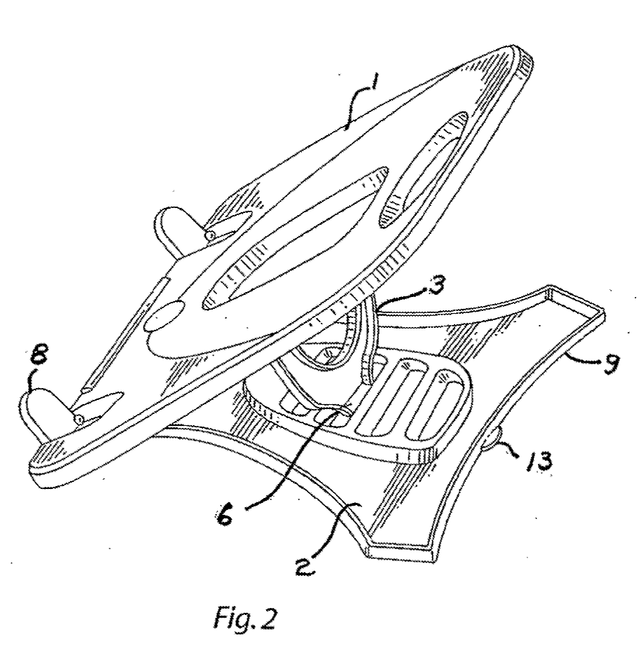

With reference to FIGS. 1 and 2, the laptop stand according to the invention is composed of: a front panel 1 for supporting the laptop when the stand is in open state, there is a heat dissipation porthole 4 for dissipating heat from the laptop on the said front panel 1; a base 2, when the base 2 is used, it is placed on the desk, one end of the base is pivoted to connect with one end of the front panel 1, that is to say, there is provided with a protruded pillar on one of the end of the front panel 1 and base 2, and there is provided with a groove corresponding to the protruded pillar on the other one end of the front panel 1 and base 2, so that the protruded pillar can pivot rotation in the groove, of course, the pivot may be a hinged structure; a supporting plate 3, when the stand is in open state, the supporting plate 3 comprises a pivoted end 5 and a locating end 6 which faces the pivoted end 5, when the stand is opened, the supporting plate 3 is formed into a structure whose side view is in triangle together with the front panel 1 and base 2, the pivoted end 5 can be pivoted to connect with one of the said front panel 1 and the said base 2, the pivoted structure is very similar to the pivoted way between the front panel 1 and base 2; and plurality of locating members 7, the said locating members 7 are provided on the other one of the said front pane 1 and the said base 2; in one embodiment, the pivoted end 5 can be pivoted to connect with the said front panel 1, and the locating members 7 are provided on the said base 2, of course, the connection may be contrary, vice versa. In the laptop stand, when the stand supports the laptop, the locating end 6 can be located on one of the plurality of locating members 7 separately, when the locating end 6 is located at the different locating members, there are different angles between the front panel 1 and base 2, that is to say, the locating members 7 are used to adjust the supporting angle of the front panel when the front panel supports the laptop.

Further, one end on the said front panel 1 which is pivoted to connect with base 2 has two or two more foldable backstop 8. The number of preferable backstop 8 is two, of course may be three, or more. When the backstops 8 are opened, they protrude upwardly from the front panel 1, and are approximately vertical to the front panel 1, so that the laptop placed on the front panel 1 cannot slip. When the laptop stand is closed together, the backstop 8 are collected to place in the groove under the front panel 1, so that it is convenient for carrying.

Moreover, when the laptop stand is folded, the front panel 1 is clipped to connect with the base 2 at the at least one position except where the front panel 1 is pivoted to connect with the base 2. The clipped connection may be that there is provided with embossment 13 on one of the front panel 1 and base 2, and there is provided with concave corresponding to the embossment on the other corresponding position, and the clipped connection may be one couple, two couples or more. When the front panel 1 and base 2 are closed together, the embossment can be pressed into the concave with force lightly, so that the front panel 1 will not be easy to separate from the base 2. The clipped connection couple is preferable to be provided on one end, which faces the pivoted connection end of the base 2, so this connection is more stable. Of course, the clipped connection may be collided connection, or the open and closure between the front panel 1 and base 2 may be the clipped connection as that between the laptop monitor and the main frame.

There is provided with protruded table 9 upwardly on the said base 2, the said plurality of locating members 7 is plurality of parallel grooves placed in the said protruded table 9. Of course, there may be not the protruded table, in this case, a plurality of parallel grooves are depressed downwardly from the top surface of the base 2, at this time, it is apparent that the base is thicker. In one example as shown in FIG. 1, the grooves functioning as the locating members 7 pass through the bottom surface of the base 2, but preferably the grooves can not pass through the bottom surface of the base 2. Preferably, the size of the said heat dissipation porthole 4 is corresponded to the said protruded table 9 so as to make the said protruded table 9 to be accommodated in the said heat dissipation porthole 4 when the said front panel 1 is folded with the said base 2.

More further, there are provided with retaining ribs 10 on periphery of the rear side of the said front panel 1 and the said heat dissipation porthole 4, which are protruded from the rear side of the said front panel, so it can increase the loading capacity of the front panel. More preferably, there are provided with retaining ribs 10 on the rear side of the said front panel 1, which are corresponded to the peripheral shape of the said base 2, and retaining ribs 10 which protrude upwardly from the base are provided on the periphery of the said base 2 on which are not pivoted. Further preferably, the retaining ribs 10 of the said front panel 1, the retaining ribs 10 of said base 2 and the said protruded table 9 have the same height, and the height of the protruded table 9 is equal to or greater than the thickness of the said supporting plate 3.

Because of this structure, when the retaining ribs 10 ensure that the whole stand has enough supporting strength, they also make the front panel 1 and the base 2 to fold compactly together, moreover, the supporting plate 3 may be sandwiched naturally between the front panel 1 and the base 2, so this reduces fully the size of the laptop stand, the laptop stand is adapted to be carried with the laptop together.

More preferably, there are provided with three or more than three skid proof pads 11 on bottom surface of the said base 2 so as to prevent the stand from sliding easily on the desk. And there are provided with a handle 12 on the said front panel 1, it is more convenient for taking the stand.

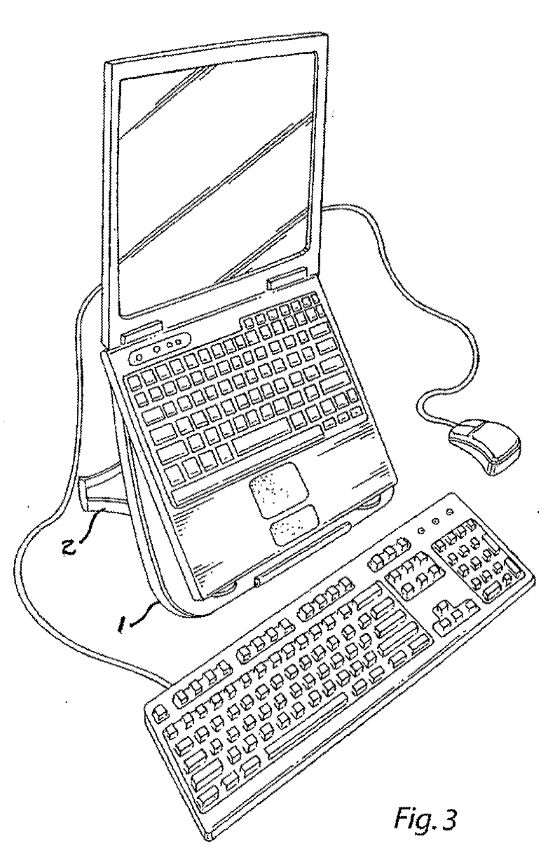

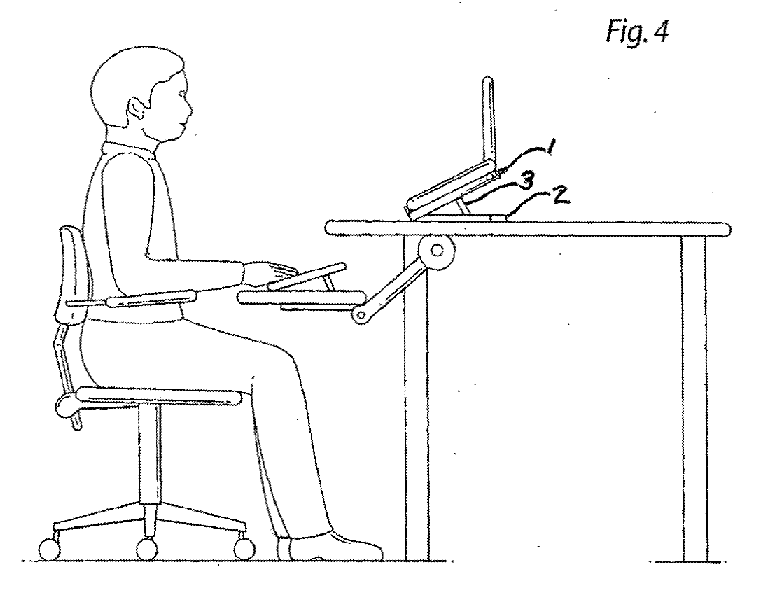

FIGS. 3 and 4 are views showing the laptop stand according to the invention is in use, in particular, with reference to FIG. 4, it can be understood that the height of the screen can be increased or decreased until it is suitable for the operator's view by adjusting jointly the opening angle of the laptop stand and the screen of the laptop. Using ergonomics theory, the working comfort of the operator can be enhanced.

It is appreciated by those skilled in the art that while the laptop stand of this invention is used to support the laptop, it can also be used to support the other office supplies too, for example, when the operator is typing, the laptop stand can be used to support the inputted document or the book, so it is very convenient the user to read, and so on.

Although having described and illustrated a preferred embodiment of the invention, it is understood by those skilled in the art that the preferred embodiment of the invention can be modified in arrangement and detail without deviating from the principle and spirit of the invention. We therefore claim all modifications and variations coming within the scope of the following claims and its equivalence.

What is claimed is:

1. A laptop stand, includes:
a front panel, there is one or more heat dissipation portholes on the said front panel;
a base, one end of the said base is pivoted to connect with one end of the said front panel;
a supporting plate, which comprises a pivoted end and a locating end which faces the said pivoted end, the said pivoted end can be pivoted to connect with one of the said front panel and the said base; and
a plurality of locating members, the said locating members are provided on the other one of the said front panel and the said base;
in which, when the said stand supports the laptop, the said locating end can be located on one of the said plurality of locating members separately.

2. The laptop stand according to claim 1, wherein one pivoted end on the said front panel has two or two more foldable backstop.

3. The laptop stand according to claim 1, wherein when the said stand is folded, the said front panel is clipped to connect with the said base at position except where the said front panel is pivoted to connect with the said base.

4. The laptop stand according to claim 1, wherein there is provided with protruded table upwardly on the said base, the said plurality of locating members are plurality of parallel grooves placed in the said protruded table.

5. The laptop stand according to claim 1, wherein the said pivoted end is pivoted to connect with the said front panel, and plurality of locating members are located on the said base.

6. The laptop stand according to claim 4, wherein the size of the said heat dissipation porthole is corresponded to the said protruded table so as to make the said protruded table to be accommodated in the said heat dissipation porthole when the said front panel is folded with the said base.

7. The laptop stand according to claim 4, wherein there are provided with retaining ribs on the periphery of the rear side of the said front panel and the said heat dissipation porthole, which are protruded from the rear side of the said front panel.

8. The laptop stand according to claim 7, wherein there are provided with retaining ribs on the rear side of the said front panel, which are corresponded to the peripheral shape of the said base, and retaining ribs which protrude upwardly from the base are provided on the periphery of the said base on which are not pivoted.

9. The laptop stand according to claim 8, wherein the retaining ribs of the said front panel, the retaining ribs of said base and the said protruded table have the same height, and the height is equal to or greater than the thickness of the said supporting plate.

10. The laptop stand according to claim 1, wherein there are provided with three or more than three skid proof pad on bottom surface of the said base, and there are provided with a handle on the said front panel.

11. The laptop stand according to claim 2, wherein there is provided with protruded table upwardly on the said base, the said plurality of locating members are plurality of parallel grooves placed in the said protruded table.

12. The laptop stand according to claim 3, wherein there is provided with protruded table upwardly on the said base, the said plurality of locating members are plurality of parallel grooves placed in the said protruded table.

13. The laptop stand according to claim 2, wherein the said pivoted end is pivoted to connect with the said front panel, and plurality of locating members are located on the said base.

14. The laptop stand according to claim 3, wherein the said pivoted end is pivoted to connect with the said front panel, and plurality of locating members are located on the said base.

15. The laptop stand according to claim 2, wherein there are provided with three or more than three skid proof pad on bottom surface of the said base, and there are provided with a handle on the said front panel.

16. The laptop stand according to claim 3, wherein there are provided with three or more than three skid proof pad on bottom surface of the said base, and there are provided with a handle on the said front panel.
